(19) United States
(12) Patent Application Publication
(10) Pub. No.: US 2024/0419577 A1
(43) Pub. Date: Dec. 19, 2024

(54) CONFIGURING A DIGITAL TWIN FOR SOFTWARE TESTING

(71) Applicant: Lenovo (Singapore) Pte. Ltd, New Tech Park (SG)

(72) Inventors: Ishan Vaishnavi, München (DE); Emmanouil Pateromichelakis, Viersen (DE)

(21) Appl. No.: 18/703,135

(22) PCT Filed: Dec. 2, 2021
(86) PCT No.: PCT/EP2021/084077

§ 371 Date: Apr. 19, 2024

(30) Foreign Application Priority Data
Oct. 19, 2021 (GR) 20210100715

(51) Int. Cl. G06F 11/36; G06F 8/65

(52) U.S. Cl. CPC G06F 11/3664; G06F 8/65

(57) ABSTRACT

Apparatuses, methods, and systems are disclosed for configuring a digital twin for software testing. One method (800) includes receiving (802), at a digital twin creation service producer, a set of parameters for creating a digital twin of a network. The method (800) includes generating (804) the digital twin based on the set of parameters. The method (800) includes transmitting (806) a request for network information and a subscription request to subscribe to changes in the network. The method (800) includes receiving (808) a response to the request. The response includes the network information and confirmation of the subscription request. The method (800) includes updating (810) the digital twin based on the network information.

### FIELD

The subject matter disclosed herein relates generally to wireless communications and more particularly relates to configuring a digital twin for software testing.

### BACKGROUND

In certain wireless communications networks, software, such as for a network function, may be updated. The updated software may need to be tested before being deployed in a final production environment.

### BRIEF SUMMARY

Methods for configuring a digital twin for software testing are disclosed. Apparatuses and systems also perform the functions of the methods. One embodiment of a method includes receiving, at a digital twin creation service producer, a set of parameters for creating a digital twin of a network. In some embodiments, the method includes generating the digital twin based on the set of parameters. In certain embodiments, the method includes transmitting a request for network information and a subscription request to subscribe to changes in the network. In various embodiments, the method includes receiving a response to the request. The response includes the network information and confirmation of the subscription request. In some embodiments, the method includes updating the digital twin based on the network information.

One apparatus for configuring a digital twin for software testing includes a digital twin creation service producer. In some embodiments, the apparatus includes a receiver that receives a set of parameters for creating a digital twin of a network. In various embodiments, the apparatus includes a processor that generates the digital twin based on the set of parameters. In certain embodiments, the apparatus includes a transmitter that transmits a request for network information and a subscription request to subscribe to changes in the network. The receiver receives a response to the request, the response includes the network information and confirmation of the subscription request, and the processor updates the digital twin based on the network information.

Another embodiment of a method for configuring a digital twin for software testing includes receiving, at a digital twin creation service producer, a set of parameters for managing at least one digital twin used for testing a new version of a software. In some embodiments, the method includes receiving a request for the at least one digital twin corresponding to the new version of the software. In certain embodiments, the method includes transmitting a response including the at least one digital twin corresponding to the new version of the software.

Another apparatus for configuring a digital twin for software testing includes a digital twin creation service producer. In some embodiments, the apparatus includes a receiver that: receives a set of parameters for managing at least one digital twin used for testing a new version of a software; and receives a request for the at least one digital twin corresponding to the new version of the software. In various embodiments, the apparatus includes a transmitter that transmits a response including the at least one digital twin corresponding to the new version of the software.

A further embodiment of a method for configuring a digital twin for software testing includes receiving, at a testing management service producer, a notification of a new version of a software. In some embodiments, the method includes transmitting a request for at least one digital twin corresponding to the new version of the software. The request includes information indicating the new version of the software. In certain embodiments, the method includes receiving a response including the at least one digital twin corresponding to the new version of the software.

A further apparatus for configuring a digital twin for software testing includes a testing management service producer. In some embodiments, the apparatus includes a receiver that receives a notification of a new version of a software. In various embodiments, the apparatus includes a transmitter that transmits a request for at least one digital twin corresponding to the new version of the software. The request includes information indicating the new version of the software. The receiver receives a response including the at least one digital twin corresponding to the new version of the software.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for configuring a digital twin for software testing;

FIG. 2 is a schematic block diagram illustrating one embodiment of an apparatus;

FIG. 3 is a schematic block diagram illustrating one embodiment of an apparatus that may be used for configuring a digital twin for software testing;

FIG. 4 is a schematic block diagram illustrating one embodiment of a system for testing new versions of NF software;

FIG. 5 is a schematic block diagram illustrating one embodiment of a system in which communications of an old version of an NF are performed by a new version of the NF;

FIG. 6 is a schematic block diagram illustrating one embodiment of communications in a system that performs NF testing against a digital twin;

FIG. 7 is a schematic block diagram illustrating one embodiment of communications in a system that creates a digital twin;

FIG. 8 is a flow chart diagram illustrating one embodiment of a method for configuring a digital twin for software testing;

FIG. 9 is a flow chart diagram illustrating another embodiment of a method for configuring a digital twin for software testing; and

FIG. 10 is a flow chart diagram illustrating a further embodiment of a method for configuring a digital twin for software testing.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

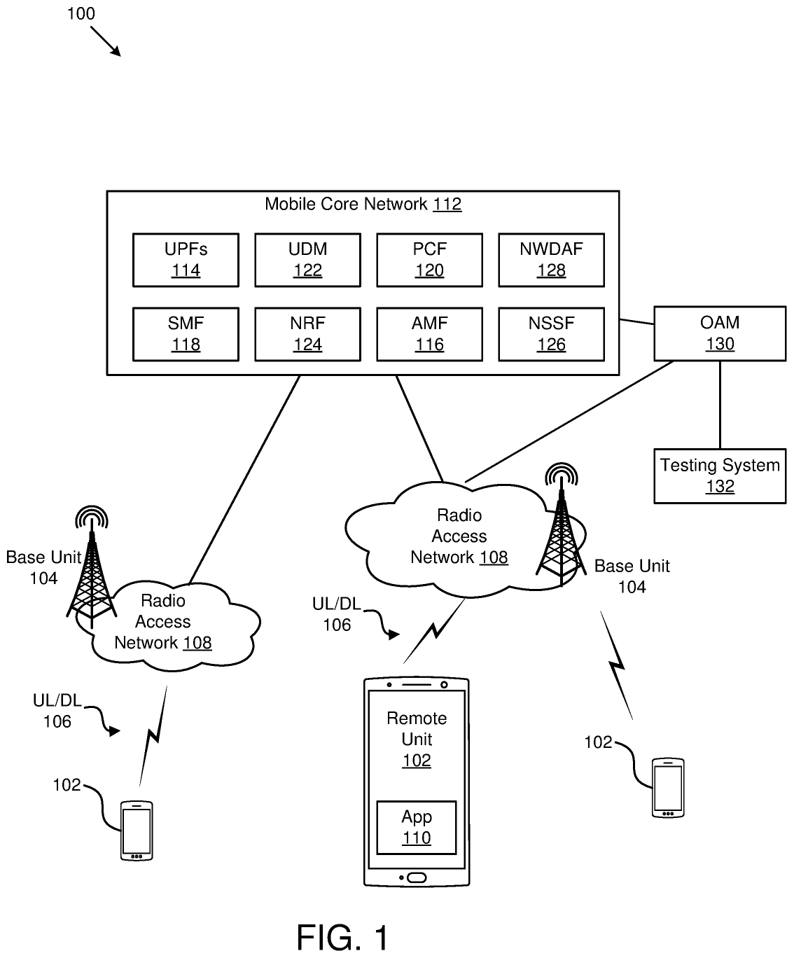

FIG. 1 depicts an embodiment of a wireless communication system 100 for configuring a digital twin for software testing. In one embodiment, the wireless communication system 100 includes remote units 102 and network units 104 (e.g., base units). Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL and/or DL communication signals 106. In certain embodiments, the remote units 102 may communicate directly with other remote units 102 via sidelink communication. The remote units 102 may include one or more software applications 110.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), a session management function (“SMF”), a user plane function (“UPF”), an application function, an authentication server function (“AUSF”), security anchor functionality (“SEAF”), trusted non-3GPP gateway function (“TNGF”), a network function, a digital twin creation service producer, a testing management service producer, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols, 5G Core, 5G Management and 5G Applications standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

The network units 104 may be part of a radio access network 108. Moreover, the radio access network 108 may communicate with a mobile core network 112. Further, the mobile core network 112 may include one or more network functions, such as UPFs 114, an AMF 116, an SMB 118, a PCT 120, a UDM 122, a network repository function (“NRF”) 124, an NSSF 126, and a network data analytics function (“NWDAF”) 128. The mobile core network 112 and/or the radio access network 108 are managed by the operations and management system (“OAM”) 130. A testing system 132 may request that the OAM 130 provide a digital twin for testing. In some embodiments, the testing system 132 may be part of the OAM 130.

In certain embodiments, the OAM 130 may receive, at a digital twin creation service producer, a set of parameters for creating a digital twin of a network. In some embodiments, the OAM 130 may generate the digital twin based on the set of parameters. In certain embodiments, the OAM 130 may transmit a request for network information and a subscription request to subscribe to changes in the network. In various embodiments, the OAM 130 may receive a response to the request. The response includes the network information and confirmation of the subscription request. In some embodiments, the OAM 130 may update the digital twin based on the network information. Accordingly, the OAM 130 may be used for configuring a digital twin for software testing.

In some embodiments, the OAM 130 may receive, at a digital twin creation service producer, a set of parameters for managing at least one digital twin used for testing a new version of a software. In some embodiments, the OAM 130 may receive a request for the at least one digital twin corresponding to the new version of the software. In certain embodiments, the OAM 130 may transmit a response including the at least one digital twin corresponding to the new version of the software. Accordingly, the OAM 130 may be used for configuring a digital twin for software testing.

In various embodiments, the OAM 130 may receive, at a testing management service producer, a notification of a new version of a software. In some embodiments, the OAM 130 may transmit a request for at least one digital twin corresponding to the new version of the software. The request includes information indicating the new version of the software. In certain embodiments, the OAM 130 may receive a response including the at least one digital twin corresponding to the new version of the software. Accordingly, the OAM 130 may be used for configuring a digital twin for software testing.

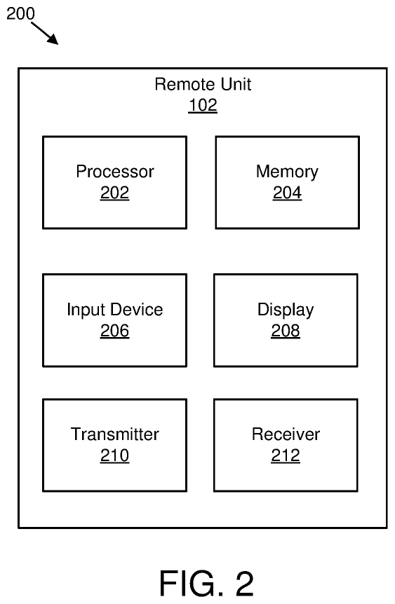

FIG. 2 depicts one embodiment of an apparatus 200. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

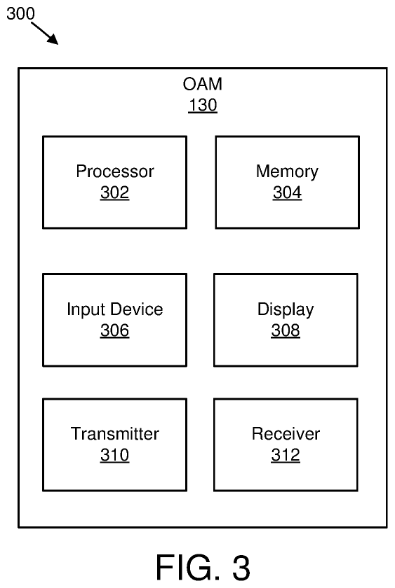

FIG. 3 depicts one embodiment of an apparatus 300 that may be used for configuring a digital twin for software testing. The apparatus 300 includes one embodiment of the OAM 130. Furthermore, the OAM 130 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312 receives a set of parameters for creating a digital twin of a network. In various embodiments, the processor 302 generates the digital twin based on the set of parameters. In certain embodiments, the transmitter 310 transmits a request for network information and a subscription request to subscribe to changes in the network. The receiver 312 receives a response to the request, the response includes the network information and confirmation of the subscription request, and the processor 302 updates the digital twin based on the network information.

In some embodiments, the receiver 312: receives a set of parameters for managing at least one digital twin used for testing a new version of a software; and receives a request for the at least one digital twin corresponding to the new version of the software. In various embodiments, the transmitter 310 transmits a response including the at least one digital twin corresponding to the new version of the software.

In various embodiments, the receiver 312 receives a notification of a new version of a software. In various embodiments, the transmitter 310 transmits a request for at least one digital twin corresponding to the new version of the software. The request includes information indicating the new version of the software. The receiver 312 receives a response including the at least one digital twin corresponding to the new version of the software.

In certain embodiments, if new versions of network functions (“NFs”) or NFs from different vendors are received by an operator, the operator may be required to test them prior to their deployment into an operational (e.g., live or production) network. In such embodiments, testing may be an expensive operation in terms of resources and time required. Testing may be performed in a continuous integration continuous deliver (“CI-CD”) pipeline and may be classified into unit tests (e.g., tests of the NF individually including installation compatibility, acceptance tests—as provided by a vendor and/or operator, integration tests—those that include the NFs function with a small set of other entities—particularly, other NFs and finally system tests that replicate the functioning of the large parts of network by replacing the new NF in it). Testing, even in such emulation environments, may be resource and/or time expensive, difficult to completely automate and control, and may not be precisely able to repeat historical occurrences in the operational network that have been known to cause certain failures or errors.

In some embodiments, testing is an important, expensive, and time-consuming activity for telecom operators that directly affects an operational expenditure bottom line. The intention of testing may be to avoid failures in a live environment that in turn could become even more expensive for the operators. A CI-CD pipeline may overcome these issues. A new version of software may go through a rigorous testing procedure including unit, integration, and system testing. In various embodiments, operational tests may be used to slowly roll out new versions of an NF software to an operator's development environment. It should be noted that, while unit tests may be easy and relatively cheap to run, they cannot capture all possible occurrences of a network and, in contrast, system and operational tests may capture previously unforeseen issues. However, system and operational tests may be extremely expensive and time consuming for an operator to run. Thus, in certain embodiments, operators may desire tests that can be as effective as system or operational tests but run at the cost close to that of unit tests.

In various embodiments, a digital twin may be a digital representation of a real-world entity or system. The implementation of a digital twin may be an encapsulated software object or model that mirrors a unique physical object, process, organization, person, or other abstraction. In certain embodiments, digital twins a digital twin instance (“DTI”) may be linked to a specific physical asset, containing information about that asset and its history, captured from sensors, tests, inspections and so on. Moreover, a digital twin aggregate (“DTA”) may be a computing construct that has access to all DTIs (e.g., an aggregate of a collection of DTIs).

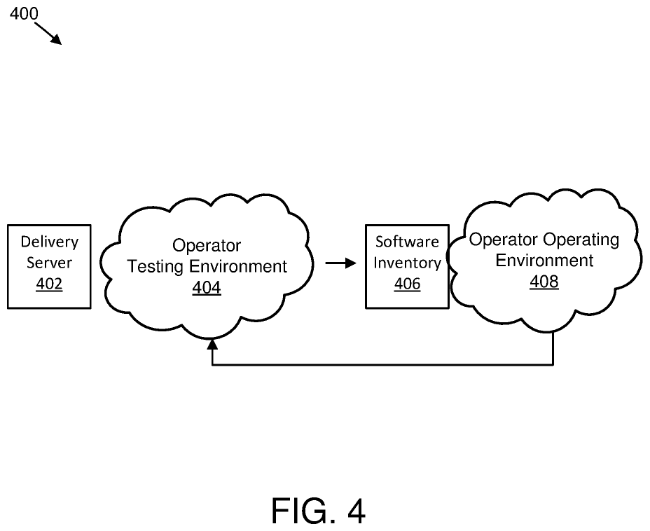

FIG. 4 is a schematic block diagram illustrating one embodiment of a system 400 for testing new versions of NF software. The system includes a delivery server 402 that may provide updated versions of an NF software to an operator testing environment 404. Moreover, the operator testing environment 404 may provide the updated versions of the NF software to a software inventory 406, which may provide the software to an operator operating environment 408 to test the NF software in a live environment. The operator operating environment 408 may provide feedback to the operator testing environment 404.

In certain embodiments, a testing environment may be periodically updated by an operator to reflect changes in an operational environment. In some embodiments, an operator testing environment management service may replicate an operational environment into a testing environment periodically. The period may be specified by an operator and may be different for different testing environments.

In various embodiments, replication of an operational environment may include: any new managed entity instantiated or removed from an operational environment, such as virtual NFs (“VNFs”), NFs, or radio equipment; and any changes in a network status, such as changes in queue lengths at switches, changes in resources used by managed entities, or changes in a number of connections a user equipment (“UE”) has.

In certain embodiments, a new NF or any software entity may be delivered to an operator for internal testing purposes. The operator may: 1) create a digital twin (e.g., digital duplicate, copy) from an updated operational environment used specifically for testing some aspects of a network; and/or 2) may reuse an existing digital twin that may represent a specific status or occurrence in past operations of the operator's network.

In some embodiments, an operator may have the ability to record historical states of an operational network in sufficient details to create a digital twin based on some events (e.g., failure of a node, dropped connections, frequent handover, service level agreement (“SLA”) failure, and so forth) that automatically create a recorded digital twin of a network that may be played back at a later stage.

In various embodiments, for the purpose of testing, a new software entity may replace an entity it is updating in a digital twin. An operator may then study the performance of the digital twin with the new software entity to see if the expected outcomes are met. If the expected outcomes are met, the test will have passed (e.g., be successful)—if not, the test is unsuccessful.

It should be noted that, whether or not the testing environment is a digital twin may be inconsequential. More importantly may be that the operational environment in replicated as accurately as possible into a “copied operational environment” and based on some pre-configured notifications (e.g., the operational environment may be recorded). Testing may be carried out against a subset of the “copied operational environments” (e.g., either a currently running environment or a historically recorded environment). As used herein, the copied operational environment may be called a digital twin.

In certain embodiments, detailed aspects of creation of a “copied operational environment” may include: 1) how frequently the changes in the operational network are copied over; and/or 2) details that include up to which open system interconnection (“OSI”) layer the changes are copied over.

In some embodiments, a new piece of software is delivered to an operator and is tested against a digital twin and an entity doing the test. In various embodiments, there may be a configuration of events that are used to record and save historical “copied operational environments”.

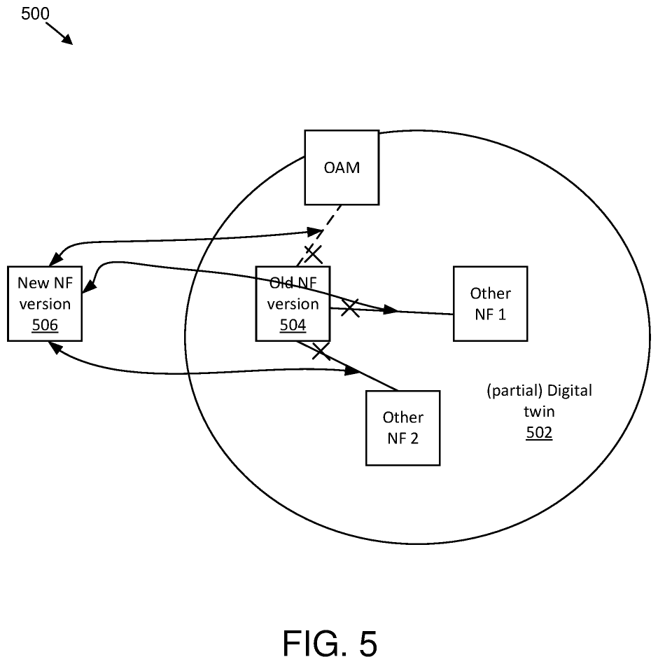

FIG. 5 is a schematic block diagram illustrating one embodiment of a system 500 in which communications of an old version of an NF are performed by a new version of the NF. Specifically, the system 500 includes a digital twin 502 (e.g., partial digital twin) having an old NF software version 504. The system 500 uses a new NF software version 506 to take over functions of the old NF software version 504. Specifically, communications are performed between the new NF software version 506 and the OAM and other network functions, instead of the old NF software version 504.

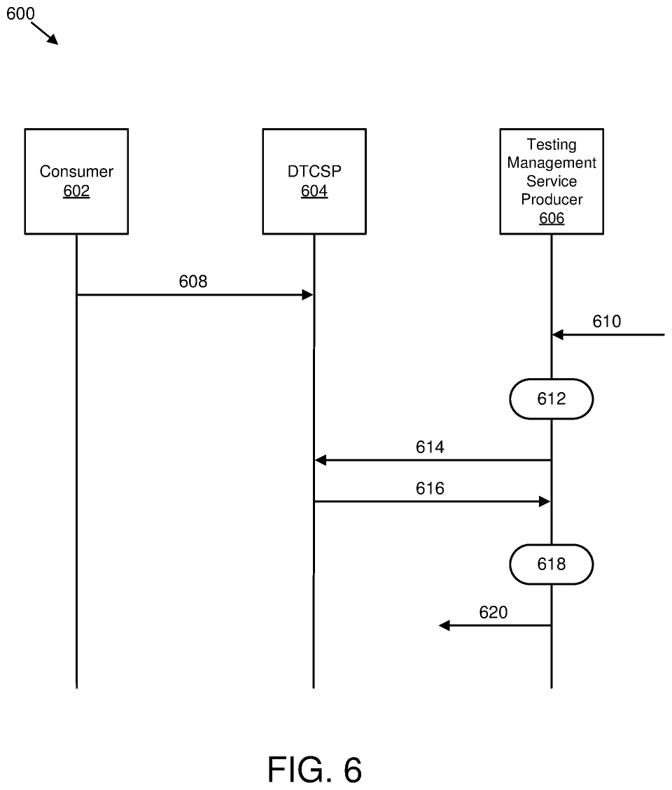

FIG. 6 is a schematic block diagram illustrating one embodiment of communications in a system 600 that performs NF testing against a digital twin. The system 600 includes a consumer 602, a digital twin creation service producer (“DTCSP”) 604, and a testing management service producer 606 (e.g., operator). Each of the described communications may include one or more messages. FIG. 6 corresponds to embodiments in which a new version of an NF is delivered to an operator.

In a first communication 608 transmitted from the consumer 602 to the DTCSP 604, an operator manages a set of test digital twins for NFs expected to be tested—including specifying that the digital twins are saved if an event occurs (e.g., previous failure of the same or a related NF). This is the set of digital twins that the NF is to be tested against. The first communication 608 may indicate an expected outcome of a test for each digital twin. The outcome may include: a success; a failure; and/or an indication that the digital twin testing is not conclusive.

In a second communication 610, a new version NF may be delivered to the testing management service producer 606 for testing. Basic acceptance tests may be performed 612 by the testing management service producer 606 to ensure that the NF is instantiable and/or executable in the operator network.

In a third communication 614 and a fourth communication 616, the testing management service producer 606 retrieves the set of testing digital twins from the DTCSP 604.

During testing, for each digital twin, all packets from a control plane, a user plane, and/or a management plane as determined by the test that are sent 618 to the older version of the NF are now sent to the new version of the NF. The replies from the new NF are captured and sent to an appropriate entity in the digital twin. It should be noted that the tests in the digital environment may be sped up or slowed down based on an operator requirement.

The result of the test may be determined based on the configuration of step 608. The result may include a particular key performance indicator (“KPI”) or an indicator that a particular unwanted condition in the network doesn't happen (e.g., such as an NF failure). In some embodiments, a test with the new NF version is successful if a specified set of objectives (e.g., in terms of performance or KPIs) is met.

The testing management service producer 606 notifies 620 appropriate subscribers and/or a communication channel about the test results.

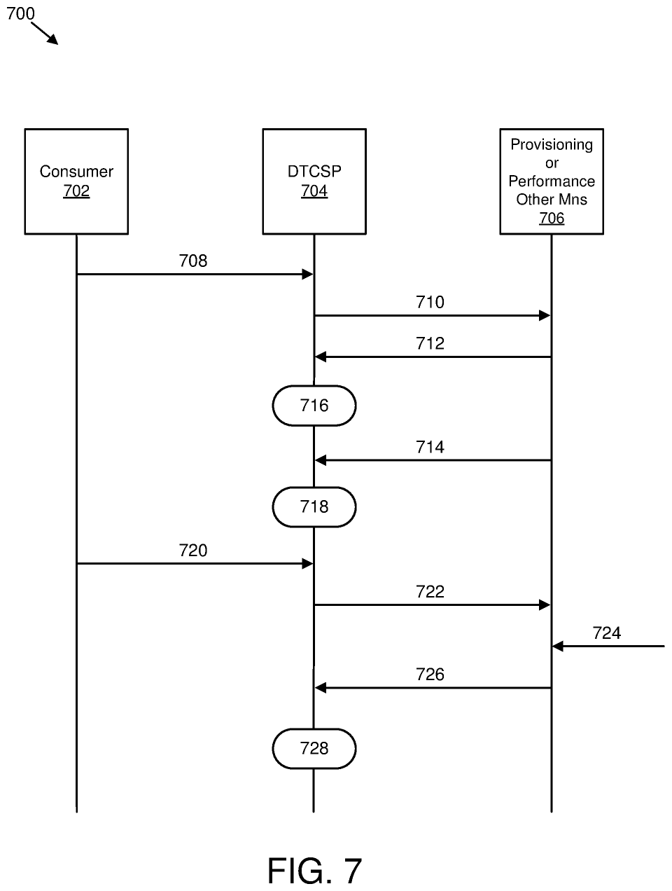

FIG. 7 is a schematic block diagram illustrating one embodiment of communications in a system 700 that creates a digital twin. The system 700 includes a consumer 702, a DTCSP 704, and a provisioning or performance other management service producer 706. Each of the described communications may include one or more messages.

In a first communication 708, the consumer 702 specifies to the DTCSP 704 various parameters for creating a digital twin of a network. The parameters may include: 1) a state of each NF in the network; 2) a level to which the NF is to be represented (e.g., does the digital twin representation include a European telecommunications standards institute (“ETSI”) network function virtualization (“NFV”) platform or only the NF level); 3) a frequency; 4) a time period; 5) a time for which the recording of events in the network are saved; 6) any other relevant details, such as external events of the network (e.g., UE registrations or internal messages such as heartbeat keep alive packets sent between NFs); 7) configurations performed by a management plane; and/or 8) if the digital twin is managed by an VNF validator, then the appropriate details of what is visible to the VNF validator as another business entity may be specified. Data privacy and protection laws may be applicable in such decisions.

In a second communication 710 (e.g., fetch network status and subscribe to appropriate changes), a third communication 712 (e.g., reply with the network status and subscribe to appropriate changes), and/or a fourth communication 714 (e.g., periodically update network change and period), based on the specification in step 708, an OAM system may report a record of the necessary details on the network and report them to the testing management service.

The DTCSP 704 stores 716 and 718 these recordings for the time duration specified in step 708. The digital twins may be updated based on the network feedback and/or may delete old irrelevant information.

In a fifth communication 720 and/or a sixth communication 722, the consumer 702 may configure network events in the operational environment such as a failure that triggers a separate “save” of the recording for the operator to reuse in a test at a later point. It should be noted that saving the digital twins may refer to saving the digital of the network being recorded in a last X or future Y duration of time around the event. X and Y may be specified and/or predetermined. Thus, multiple different versions over the X or Y period of time may be saved.

In a seventh communication 724 (e.g., receive configured event notification), an eighth communication 726 (e.g., transmit configured event notification), and/or step 728 (e.g., save the network digital twin corresponding to the event), if the event is triggered, a separate save of the digital twin is executed.

It should be noted that there may be a group of NFs being tested simultaneously. The part being tested may be replaced in the digital twin. In some embodiments, if a new version of software changes the replies to the messages received from the digital twin significantly, then other network functions may need to be realized too. In various embodiments, there may be multiple test digital twins depending on the NF being tested. In certain embodiments, a testing management service and a digital twin creation service may be merged with other services. The testing management service may be implemented as a general provisioning service with an appropriate test description.

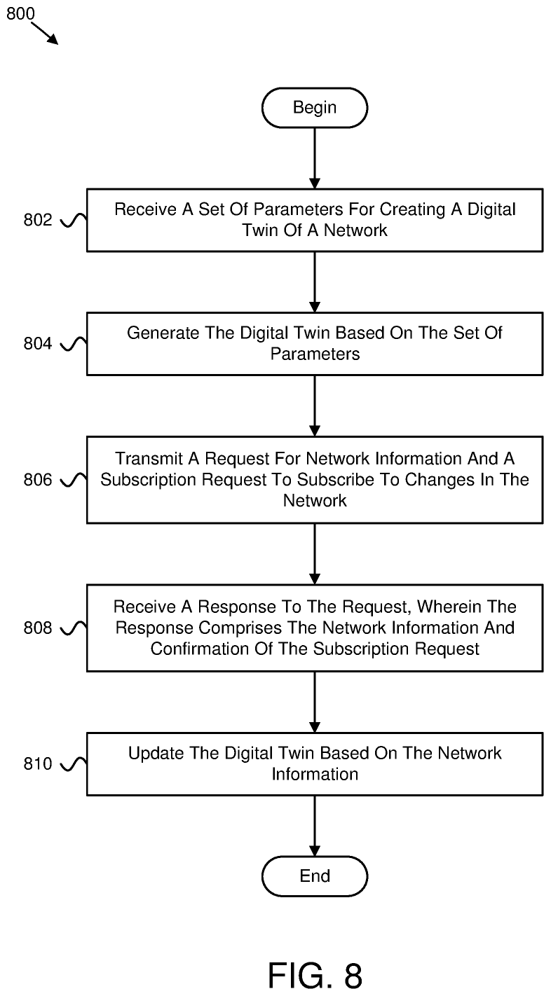

FIG. 8 is a flow chart diagram illustrating one embodiment of a method 800 for configuring a digital twin for software testing. In some embodiments, the method 800 is performed by an apparatus, such as the OAM 130. In certain embodiments, the method 800 may be performed by a processor executing program code, for example, a microcontroller, a microprocessor, a CPU, a GPU, an auxiliary processing unit, a FPGA, or the like.

In various embodiments, the method 800 includes receiving 802, at a digital twin creation service producer, a set of parameters for creating a digital twin of a network. In some embodiments, the method 800 includes generating 804 the digital twin based on the set of parameters. In certain embodiments, the method 800 includes transmitting 806 a request for network information and a subscription request to subscribe to changes in the network. In various embodiments, the method 800 includes receiving 808 a response to the request. The response includes the network information and confirmation of the subscription request. In some embodiments, the method 800 includes updating 810 the digital twin based on the network information.

In certain embodiments, the set of parameters comprises: a state of each network function in the network, a level for each network function to be represented, a frequency, a time duration, a time for recorded network events to be saved, external network events, configurations performed by a management plane, visibility information, open standards interconnect level, an application plane, a management plane, a control user plane, a virtualization plane, or some combination thereof. In some embodiments, the method 800 further comprises receiving data as a response to the subscription request and updating the digital twin based on the data.

In various embodiments, the method 800 further comprises receiving event configuration information, wherein the event configuration information indicates a trigger event and an action initiated in response to the trigger event. In one embodiment, the trigger event causes a save of the digital twin. In certain embodiments, the trigger event comprises a network failure, a specified change in the network, a rollout of new software, a removal of old software, a configurable notification, a time trigger, a key performance indicator threshold crossing, or some combination thereof.

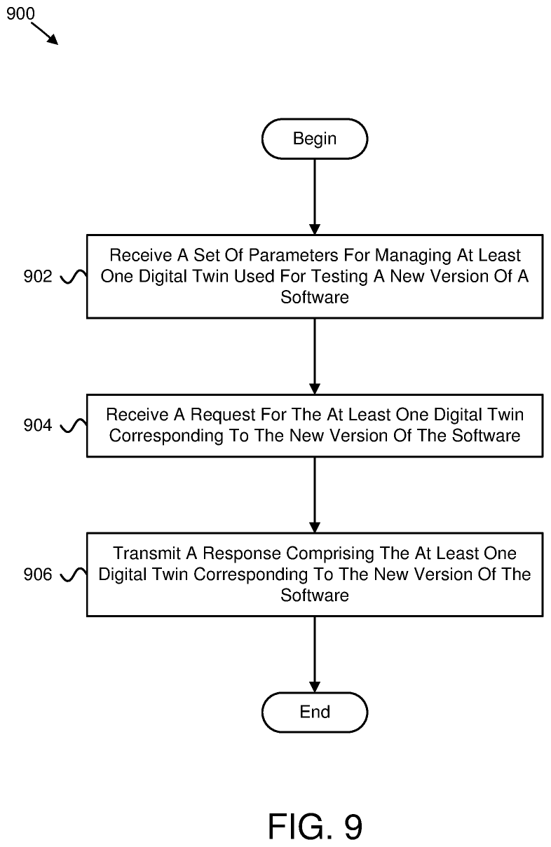

FIG. 9 is a flow chart diagram illustrating another embodiment of a method 900 for configuring a digital twin for software testing. In some embodiments, the method 900 is performed by an apparatus, such as the OAM 130. In certain embodiments, the method 900 may be performed by a processor executing program code, for example, a microcontroller, a microprocessor, a CPU, a GPU, an auxiliary processing unit, a FPGA, or the like.

In various embodiments, the method 900 includes receiving 902, at a digital twin creation service producer, a set of parameters for managing at least one digital twin used for testing a new version of a software. In some embodiments, the method 900 includes receiving 904 a request for the at least one digital twin corresponding to the new version of the software. In certain embodiments, the method 900 includes transmitting 906 a response including the at least one digital twin corresponding to the new version of the software.

In certain embodiments, the set of parameters comprises information indicating criteria for a successful test of the new version of the software against the at least one digital twin, information indicating criteria for a failed test of the new version of the software against the at least one digital twin, information indicating criteria for an inconclusive test of the software against the at least one digital twin, or a combination thereof. In some embodiments, the request for the at least one digital twin is received from a testing management service producer and specifies the new version of the software for testing, and the response comprising the at least one digital twin is sent to the testing management service producer. In various embodiments, managing the at least one digital twin comprises creating the at least one digital twin, configuring the at least one digital twin, reading the at least one digital twin, updating the at least one digital twin, deleting the at least one digital twin, or a combination thereof.

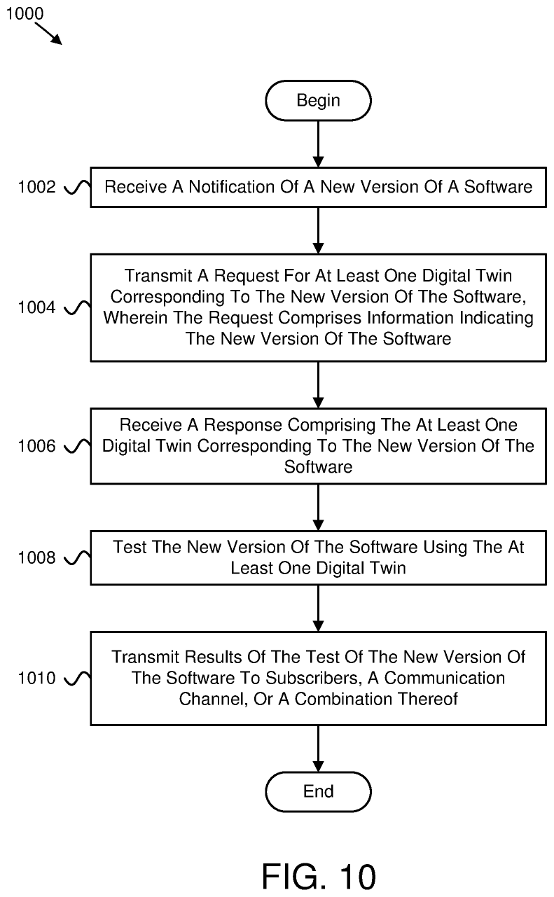

FIG. 10 is a flow chart diagram illustrating a further embodiment of a method 1000 for configuring a digital twin for software testing. In some embodiments, the method 1000 is performed by an apparatus, such as the OAM 130. In certain embodiments, the method 1000 may be performed by a processor executing program code, for example, a microcontroller, a microprocessor, a CPU, a GPU, an auxiliary processing unit, a FPGA, or the like.

In various embodiments, the method 1000 includes receiving 1002, at a testing management service producer, a notification of a new version of a software. In some embodiments, the method 1000 includes transmitting 1004 a request for at least one digital twin corresponding to the new version of the software. The request includes information indicating the new version of the software. In certain embodiments, the method 1000 includes receiving 1006 a response including the at least one digital twin corresponding to the new version of the software.

In certain embodiments, the method 1000 further comprises testing 1008 the new version of the software using the at least one digital twin. In some embodiments, testing the new version of the software using the at least one digital twin comprises testing all packets from a control plane, a user plane, a management plane, or a combination thereof that are sent to an older version of the software with the new version of the software. In various embodiments, the method 1000 further comprises transmitting 1010 results of the test of the new version of the software to subscribers, a communication channel, or a combination thereof.

In one embodiment, a method of a digital twin creation service producer comprises: receiving a set of parameters for creating a digital twin of a network; generating the digital twin based on the set of parameters; transmitting a request for network information and a subscription request to subscribe to changes in the network; receiving a response to the request, wherein the response comprises the network information and confirmation of the subscription request; and updating the digital twin based on the network information.

In certain embodiments, the set of parameters comprises: a state of each network function in the network, a level for each network function to be represented, a frequency, a time duration, a time for recorded network events to be saved, external network events, configurations performed by a management plane, visibility information, open standards interconnect level, an application plane, a management plane, a control user plane, a virtualization plane, or some combination thereof.

In some embodiments, the method further comprises receiving data as a response to the subscription request and updating the digital twin based on the data.

In various embodiments, the method further comprises receiving event configuration information, wherein the event configuration information indicates a trigger event and an action initiated in response to the trigger event.

In one embodiment, the trigger event causes a save of the digital twin.

In certain embodiments, the trigger event comprises a network failure, a specified change in the network, a rollout of new software, a removal of old software, a configurable notification, a time trigger, a key performance indicator threshold crossing, or some combination thereof.

In one embodiment, an apparatus comprises a digital twin creation service producer. The apparatus further comprises: a receiver that receives a set of parameters for creating a digital twin of a network; a processor that generates the digital twin based on the set of parameters; and a transmitter that transmits a request for network information and a subscription request to subscribe to changes in the network, wherein the receiver receives a response to the request, the response comprises the network information and confirmation of the subscription request, and the processor updates the digital twin based on the network information.

In certain embodiments, the set of parameters comprises: a state of each network function in the network, a level for each network function to be represented, a frequency, a time duration, a time for recorded network events to be saved, external network events, configurations performed by a management plane, visibility information, open standards interconnect level, an application plane, a management plane, a control user plane, a virtualization plane, or some combination thereof.

In some embodiments, the receiver receives data as a response to the subscription request and updating the digital twin based on the data.

In various embodiments, the receiver receives event configuration information, and the event configuration information indicates a trigger event and an action initiated in response to the trigger event.

In one embodiment, the trigger event causes a save of the digital twin.

In certain embodiments, the trigger event comprises a network failure, a specified change in the network, a rollout of new software, a removal of old software, a configurable notification, a time trigger, a key performance indicator threshold crossing, or some combination thereof.

In one embodiment, a method of a digital twin creation service producer comprises: receiving a set of parameters for managing at least one digital twin used for testing a new version of a software; receiving a request for the at least one digital twin corresponding to the new version of the software; and transmitting a response comprising the at least one digital twin corresponding to the new version of the software.

In certain embodiments, the set of parameters comprises information indicating criteria for a successful test of the new version of the software against the at least one digital twin, information indicating criteria for a failed test of the new version of the software against the at least one digital twin, information indicating criteria for an inconclusive test of the software against the at least one digital twin, or a combination thereof.

In some embodiments, the request for the at least one digital twin is received from a testing management service producer and specifies the new version of the software for testing, and the response comprising the at least one digital twin is sent to the testing management service producer.

In various embodiments, managing the at least one digital twin comprises creating the at least one digital twin, configuring the at least one digital twin, reading the at least one digital twin, updating the at least one digital twin, deleting the at least one digital twin, or a combination thereof.

In one embodiment, an apparatus comprises a digital twin creation service producer. The apparatus further comprises: a receiver that: receives a set of parameters for managing at least one digital twin used for testing a new version of a software; and receives a request for the at least one digital twin corresponding to the new version of the software; and a transmitter that transmits a response comprising the at least one digital twin corresponding to the new version of the software.

In certain embodiments, the set of parameters comprises information indicating criteria for a successful test of the new version of the software against the at least one digital twin, information indicating criteria for a failed test of the new version of the software against the at least one digital twin, information indicating criteria for an inconclusive test of the software against the at least one digital twin, or a combination thereof.

In some embodiments, the request for the at least one digital twin is received from a testing management service producer and specifies the new version of the software for testing, and the response comprising the at least one digital twin is sent to the testing management service producer.

In various embodiments, managing the at least one digital twin comprises creating the at least one digital twin, configuring the at least one digital twin, reading the at least one digital twin, updating the at least one digital twin, deleting the at least one digital twin, or a combination thereof.

In one embodiment, a method of a testing management service producer comprises: receiving a notification of a new version of a software; transmitting a request for at least one digital twin corresponding to the new version of the software, wherein the request comprises information indicating the new version of the software; and receiving a response comprising the at least one digital twin corresponding to the new version of the software.

In certain embodiments, the method further comprises testing the new version of the software using the at least one digital twin.

In some embodiments, testing the new version of the software using the at least one digital twin comprises testing all packets from a control plane, a user plane, a management plane, or a combination thereof that are sent to an older version of the software with the new version of the software.

In various embodiments, the method further comprises transmitting results of the test of the new version of the software to subscribers, a communication channel, or a combination thereof.

In one embodiment, an apparatus comprises a testing management service producer. The apparatus further comprises: a receiver that receives a notification of a new version of a software; and a transmitter that transmits a request for at least one digital twin corresponding to the new version of the software, wherein the request comprises information indicating the new version of the software, wherein the receiver receives a response comprising the at least one digital twin corresponding to the new version of the software.

In certain embodiments, the apparatus further comprises a processor that tests the new version of the software using the at least one digital twin.

In some embodiments, testing the new version of the software using the at least one digital twin comprises testing all packets from a control plane, a user plane, a management plane, or a combination thereof that are sent to an older version of the software with the new version of the software.

In various embodiments, the transmitter transmits results of the test of the new version of the software to subscribers, a communication channel, or a combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of performing a network function, the method comprising:
receiving a set of parameters for managing at least one digital twin used for testing a new version of a software;
receiving a request for the at least one digital twin corresponding to the new version of the software; and
transmitting a response comprising the at least one digital twin corresponding to the new version of the software.

2. The method of claim 1, wherein the set of parameters comprises information indicating criteria for a successful test of the new version of the software against the at least one digital twin, information indicating criteria for a failed test of the new version of the software against the at least one digital twin, information indicating criteria for an inconclusive test of the software against the at least one digital twin, or a combination thereof.

3. The method of claim 1, wherein the request for the at least one digital twin comprises the new version of the software for testing, and the response comprising the at least one digital twin is sent to a testing management service producer.

4. The method of claim 1, wherein managing the at least one digital twin comprises creating the at least one digital twin, configuring the at least one digital twin, reading the at least one digital twin, updating the at least one digital twin, deleting the at least one digital twin, or a combination thereof.

5. An apparatus for performing a network function, the apparatus further comprising:
at least one memory; and
at least one processor coupled with the at least one memory and configured to cause the apparatus to:
receive a first set of parameters for managing at least one digital twin used for testing a new version of a software; and
receive a first request for the at least one digital twin corresponding to the new version of the software; and
transmit a first response comprising the at least one digital twin corresponding to the new version of the software.

6. The apparatus of claim 5, wherein the first set of parameters comprises information indicating criteria for a successful test of the new version of the software against the at least one digital twin, information indicating criteria for a failed test of the new version of the software against the at least one digital twin, information indicating criteria for an inconclusive test of the software against the at least one digital twin, or a combination thereof.

7. The apparatus of claim 5, wherein the first request for the at least one digital twin comprises the new version of the software for testing, and the first response comprising the at least one digital twin is sent to a testing management service producer.

8. The apparatus of claim 5, wherein the at least one processor is configured to cause the apparatus to:
receive a second set of parameters for creating the at least one digital twin of a network;
generate the at least one digital twin based on the second set of parameters; and
transmit a second request for network information and a subscription request to subscribe to changes in the network;
receive a second response to the request,
wherein the second response comprises the network information and confirmation of the subscription request; and
update the digital twin based on the network information.

9. The apparatus of claim 8, wherein the second set of parameters comprises: a state of each network function in the network, a level for each network function to be represented, a frequency, a time duration, a time for recorded network events to be saved, external network events, configurations performed by a management plane, visibility information, open standards interconnect level, an application plane, a management plane, a control user plane, a virtualization plane, or a combination thereof.

10. The apparatus of claim 8, wherein the receiver receives data as a third response to the subscription request and the processor updates the digital twin based on the data.

11. The apparatus of claim 8, wherein the receiver receives event configuration information, and the event configuration information indicates a trigger event and an action initiated in response to the trigger event, the trigger event causes a save of the digital twin, and the trigger event comprises a network failure, a specified change in the network, a rollout of new software, a removal of old software, a configurable notification, a time trigger, a key performance indicator threshold crossing, or a combination thereof.

12. An apparatus for performing a network function, the apparatus comprising:
at least one memory; and
at least one processor coupled with the at least one memory and configured to cause the apparatus to:
receive a notification of a new version of a software; and
transmit a request for at least one digital twin corresponding to the new version of the software, wherein the request comprises information indicating the new version of the software, wherein the at least one processor is configured to cause the apparatus to receive a response comprising the at least one digital twin corresponding to the new version of the software.

13. The apparatus of claim 12, wherein the at least one processor is configured to cause the apparatus to test the new version of the software using the at least one digital twin.

14. The apparatus of claim 13, wherein testing the new version of the software using the at least one digital twin comprises testing all communication of an older version of the software with the new version of the software including communication as part of a control plane, a user plane, a management plane, or a combination thereof.

15. The apparatus of claim 13, wherein the at least one processor is configured to cause the apparatus to transmit results of the test of the new version of the software to subscribers, a communication channel, or a combination thereof.

16. A method of performing a network function, the method comprising:
receiving a notification of a new version of a software;
transmitting a request for at least one digital twin corresponding to the new version of the software, wherein the request comprises information indicating the new version of the software; and
receiving a response comprising the at least one digital twin corresponding to the new version of the software.

17. The method of claim 16, further comprising testing the new version of the software using the at least one digital twin.

18. The method of claim 17, further comprising testing the new version of the software using the at least one digital twin comprises testing all communication of an older version of the software with the new version of the software including communication as part of a control plane, a user plane, a management plane, or a combination thereof.

19. The method of claim 17, further comprising transmitting results of the test of the new version of the software to subscribers, a communication channel, or a combination thereof.
